(19) United States
(12) Patent Application Publication
(10) Pub. No.: US 2019/0195422 A1
(43) Pub. Date: Jun. 27, 2019

(54) FINGER-CONTROLLED 360° RECORDING MOBILE PHONE ROTARY HANDHELD DEVICE

(71) Applicants: Huynh Cong Nhan, Ho Chi Minh City (VN); Huynh Cong Nghia, Ho Chi Minh City (VN)

(72) Inventors: Huynh Cong NHAN, Ho Chi Minh City (VN); Huynh Cong NGHIA, Ho Chi Minh City (VN); Huynh Nguyen Phuong UYEN, Ho Chi Minh City (VN)

(21) Appl. No.: 16/309,661

(22) PCT Filed: Jun. 2, 2017
(86) PCT No.: PCT/VN2017/000004

§ 371 Date: Dec. 13, 2018

(30) Foreign Application Priority Data
Jun. 16, 2016 (VN) 1-2016-02214

(51) Int. Cl. F16M 13/04; F16B 2/12; F16M 11/08; F16M 11/18; F16M 11/04; F16H 1/12; F16H 25/20

(52) U.S. Cl. CPC F16M 13/04; F16B 2/12; F16M 11/08; F16M 11/18; H04M 1/04; F16H 1/12; F16H 25/20; F16M 2200/022; F16H 2025/2028; F16M 11/041

(57) ABSTRACT

The device controlled by a finger allows the mobile phone record videos around the user. The device includes main parts: 1—mobile phone holding frame, 2—pivot to receive external force to create rotary motion on the pivot, thus, enable the pivot to rotate freely, 3—handle enabling the user to hold the 360° mobile phone rotary device in the palm of the user's hand to create an angle between the grip and the mobile phone, in addition, a 360° mobile phone rotating device may be added: 4—couplings or extensions to extend the handle and pivot holding frame or to increase the length between the handle and the pivot holding frame A and to create the angle between the handle and the mobile phone at will, 5—cable inside the cable conduit to transfer the rotational motion from the handle to the mobile phone holding frame, 6—curved or straight bars tangent to the pivot with reciprocating motion obtained by the external force and held by the gap between the horizontal bars on the shaft retainer.

### TECHNICAL FIELD

The invention in field of mobile phone supporting handheld devices (smartphones) captures the panoramic scene in a convenient way by rotating the mobile phone with smaller or larger than 360° in comparison with rotational direction and speed as desired by fingers.

### BACKGROUND OF THE INVENTION

Demand of recording, viewing and sending images and movies with a mobile phone (smartphone) are rising. Especially, social networks such as Facebook, YouTube, etc. begin to support transforming ordinary images and movies into panoramic ones as the spectators can rotate to view the whole panoramic scene.

Currently recording is done by holding the mobile phone and turning around or turn the hand holding the mobile phone to record images around the user with an expensive devices which are composed of multiple cameras mounted on a round ring or on a spherical surface.

In order to capture the panorama recorded with a 360° arc around a person holding a video recorder or a mobile phone (hereinafter referred to as a mobile phone, implicitly known as a smartphone, or automatic smart video recorder) by turning with an angle of 360 degrees, there is lots of inconvenience because it is impossible to record the image of a mobile phone user if the mobile phone's camera is facing out of the user's body. On the contrary, the mobile phone will obscure most of the scene that needs to be recorded by the user's body when the mobile phone's camera is aimed at the user's body.

Turning a mobile phone manually will be difficult to keep at a slow and steady speed, and it is consequently difficult to avoid undulation when turning, therefore the recorded images or video will have low quality: images of the video will easily be blur or undulated and be at an inconsistent speed, and it is easy for mobile phones to fall.

Recording with specialized devices equipped with cameras around a circular arc or cameras mounted around a spherical surface to capture a panoramic image of a 360 arc requires two devices to separately record 360° arc and view a single image of a 360° arc, thus dramatically increase the cost of shopping for 360 video recording devices for mobile phone users. In addition the image is recorded and reassembled into a 360° arc by different cameras may experience problems with poor communication at the edges of the images of different cameras.

The invention concerning a handheld device or instrument that supports a video recorder (camera) for the purpose of self-recording as the U.S. Pat. No. 4,530,580 by Hiroshi Ueda, Yujiro Mima, issued on Jul. 23, 1985 about an expandable sight instrument for the camera. The device is rod-shaped, retractable like a fishing rod. It can be expended with one end, a handle held with the user's hand, and there is a button used to control the recording on the handle. This button is also connected by a wire to the jack on the recorder. On the other end of the rod there is a bar of which length is approximately equal to the height of the recorder and connected perpendicularly to the rod. On the long bar there is a bolt that is perpendicular to the long rod and this bolt is used to tighten a holed recorder with a female thread to tighten the bolts into the recorder feet. When used, the camcorder is screwed into the bolt so that the lens face towards the user and the user can press the button on the handle to record. The camera position can change its angle in comparison with the stick by turning the camcorder against the long bar so that the user changes the angle between the stick and the user's body while the lens is still facing the user. This invention is one of the first inventions of a camera-supported handheld device so that the user can self-capture. However this invention does not have the function of supporting a video recorder in order to capture panoramic image around by finger-controlled device that the user must turn about or turn the handle of it to capture.

So far there is no mobile phone rotary hand-held device for finger-controlled 360° recording. It is therefore necessary for the mobile phone user to have a portable recorder at hand so that he can capture the surrounding panoramic view conveniently and can deliver high quality images and movies that can be used to create 360° ones for viewers.

Following description is of a finger-controlled 360° mobile phone rotary hand-held device that will meet those needs for mobile phone users or mobile video recorders. Portable recording allows mobile phone record in a circular arc, especially with a circular arc of over 180°, with slow mobile phone rotation, fairly uniform rotational speed, as well as less undulation and allows recording direction according to user's wishes.

### SUMMARY OF THE INVENTION

The invention is a handheld device for recording with a camera or portable recorder and its most common application is to support camera-equipped mobile phones and those of which monitors can be turned a 360° arc with a finger (hereinafter referred to as “device”), hereinafter referred to as a finger-controlled 360° mobile phone turning device. On using finger-controlled 360° mobile phone turning device, the camera of the mobile phone will record an arc of its own accord with a smooth finger-controlled rotational motion, to and fro and fast or slow as the user's desire is. In addition, the recording arc may have small angle or up to 360° or rotate repeatedly.

Images recorded by a mobile phone with a finger-controlled 360° rotary device, along with 360° image or video processing software for 360° image processing, of which advantage is that film or video will have better consistency than those connected by individual cameras mounted on the perimeter of a circular device or on the surface of the spherical device.

The device of the invention has the feature of rotating the mobile phone so that the camera of the device can record in a circular arc with the control of the rotational speed, rotation, the desired arc length with the fingers and hands holding the mobile phone.

The device of the invention has a number of different forms, however, the rotational control of the cell phone is based on the operation of the finger. These types of device have different manipulations to control the rotation of the mobile phone at will, namely as follows.

### BRIEF DESCRIPTION OF THE DRAWINGS

FIG. 1.1: Control device by directly rotating pivot with fingers of the hand holding the mobile phone which is held by a retainer to the two surfaces of the mobile phone.

FIG. 1.2: Description of the device seen from the left, according to FIG. 1.1.

FIG. 1.3: Control device by directly rotating pivot with fingers of the hand holding the mobile phone which is held by a retainer to the two surfaces of the mobile phone.

FIG. 1.4: Description of the device seen from the left, according to FIG. 1.3.

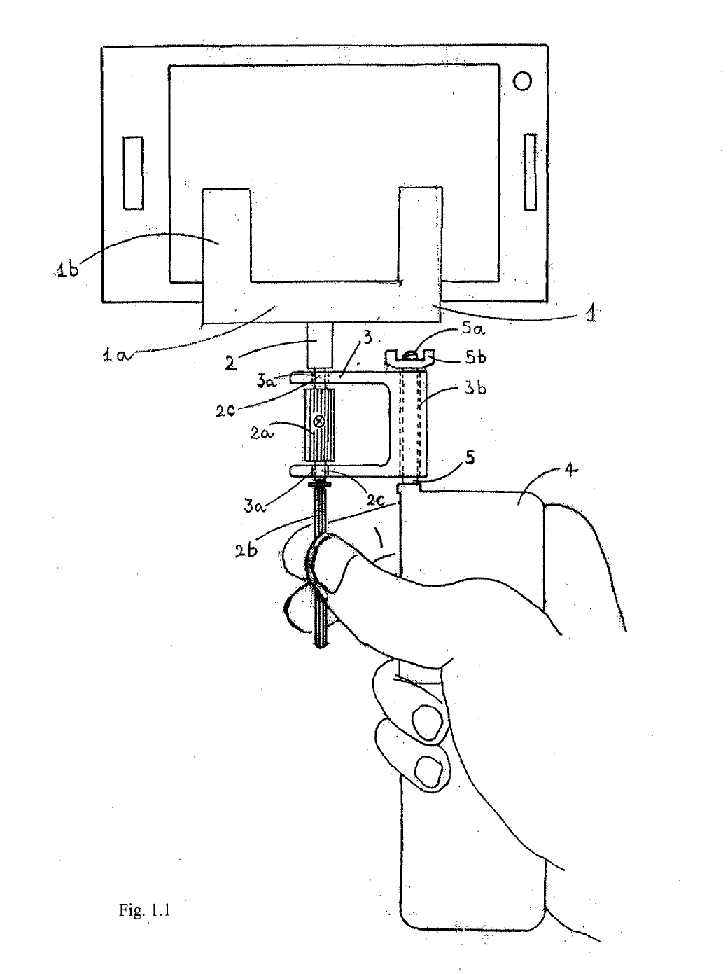

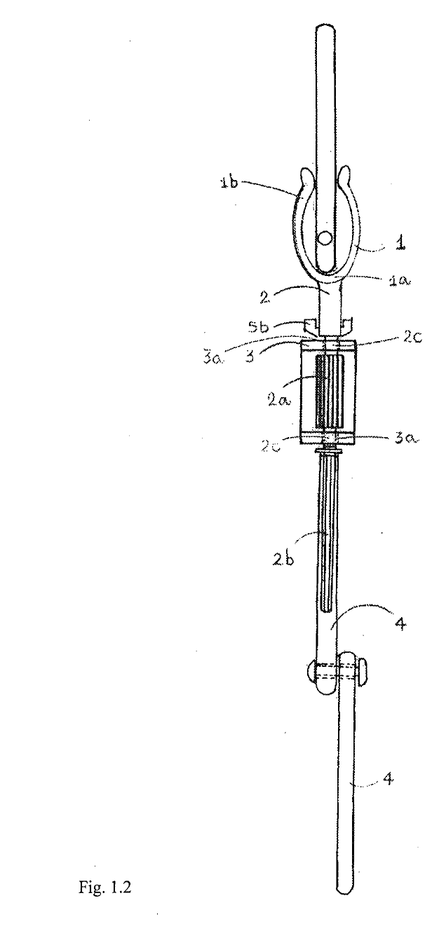

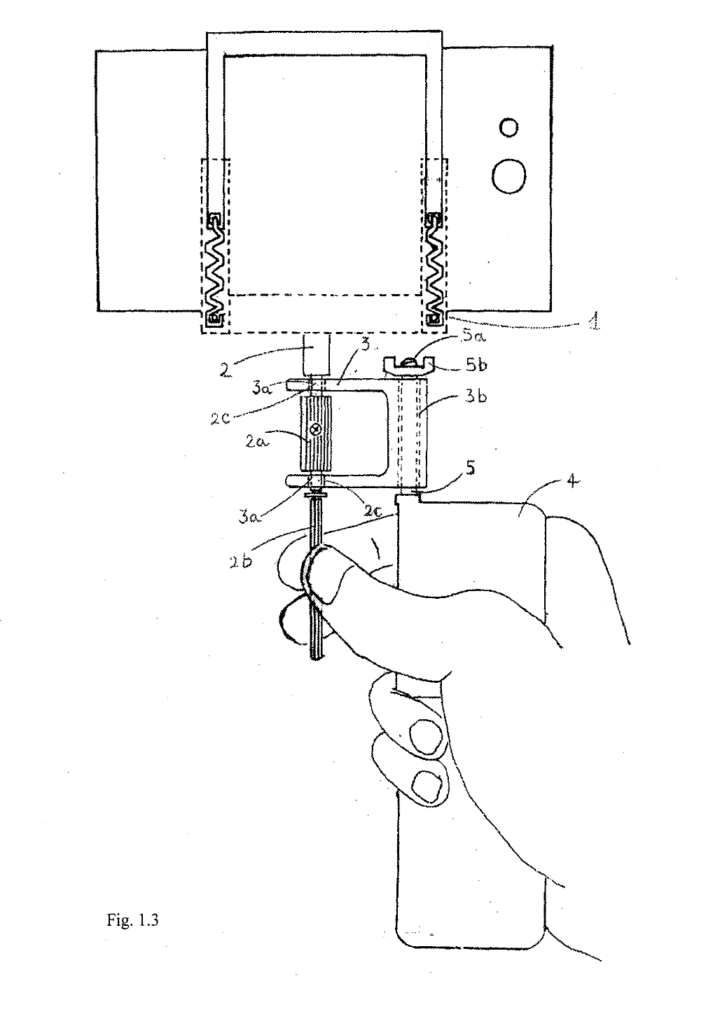

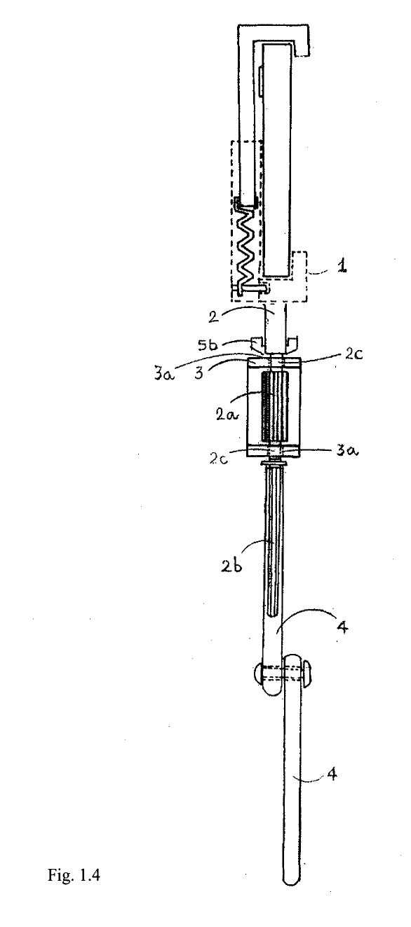

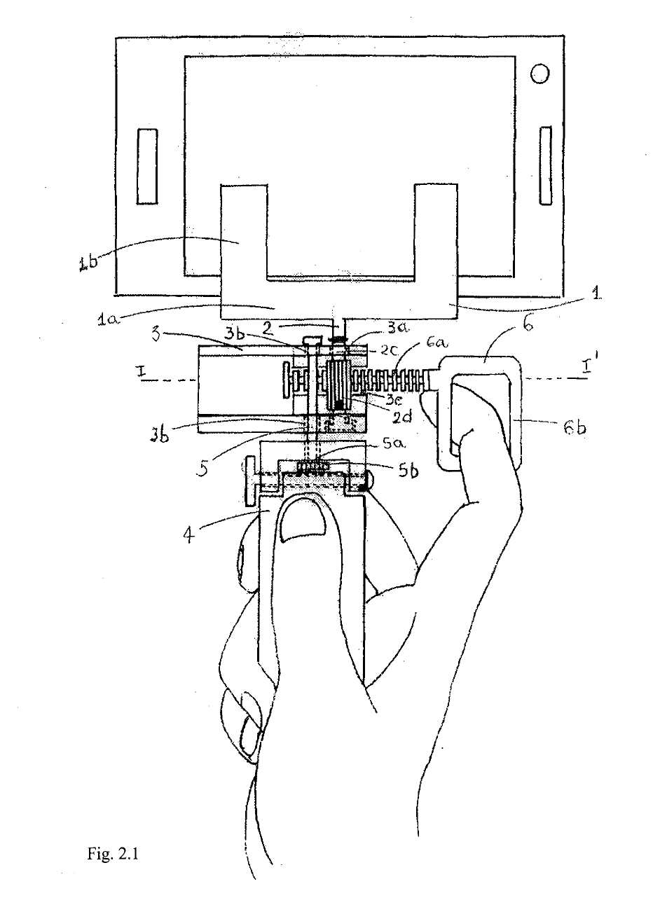

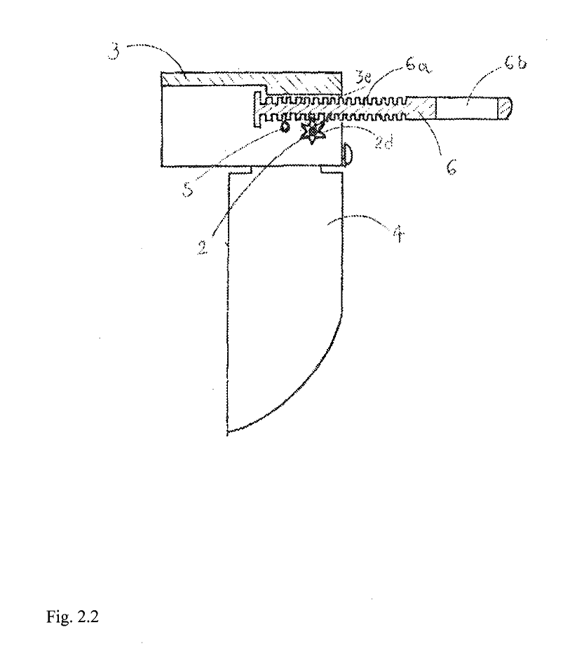

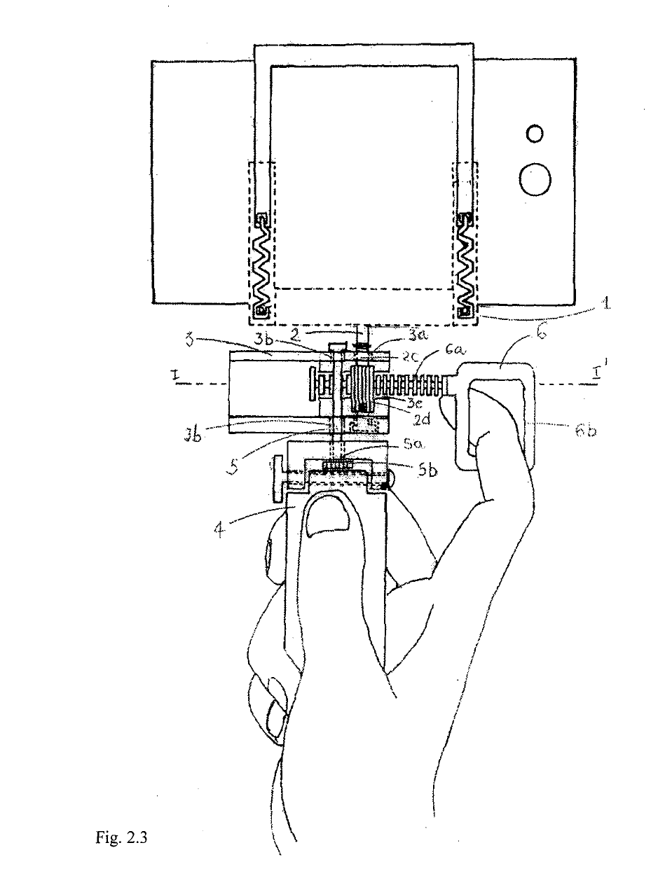

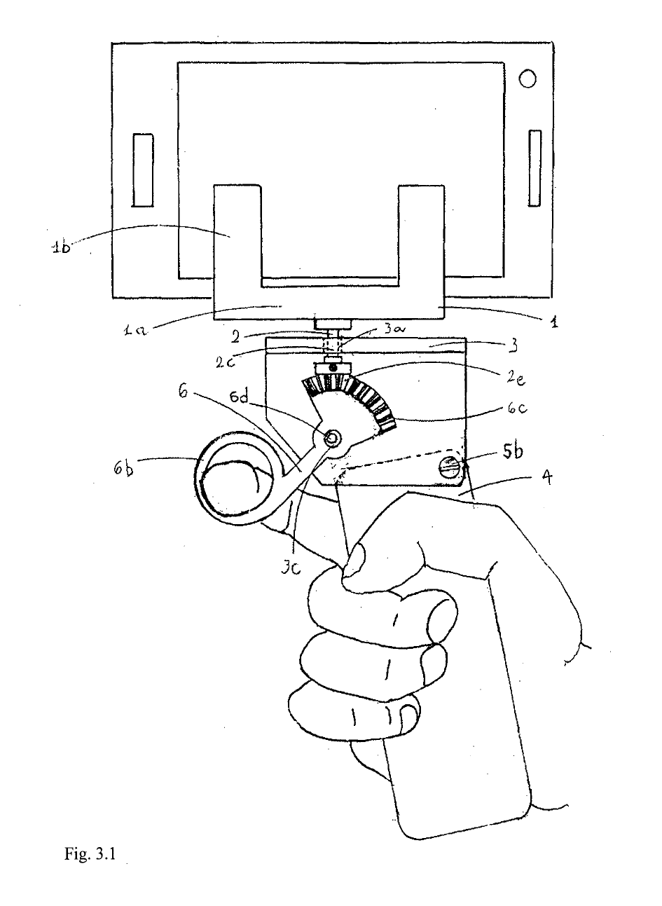

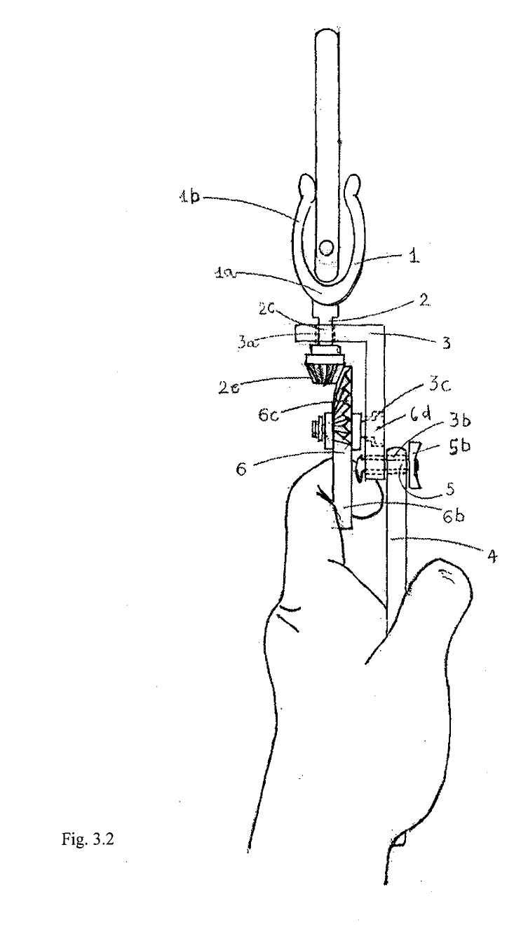

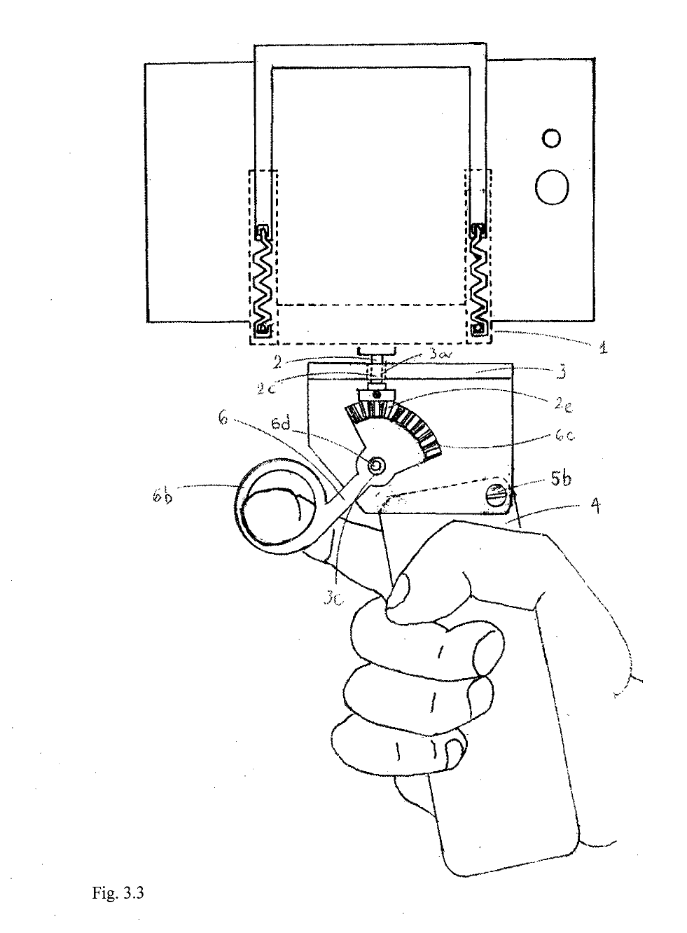

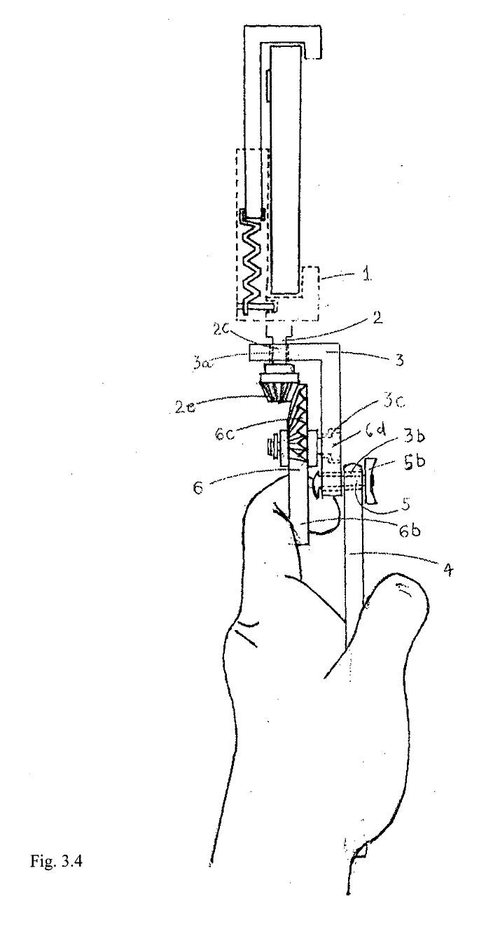

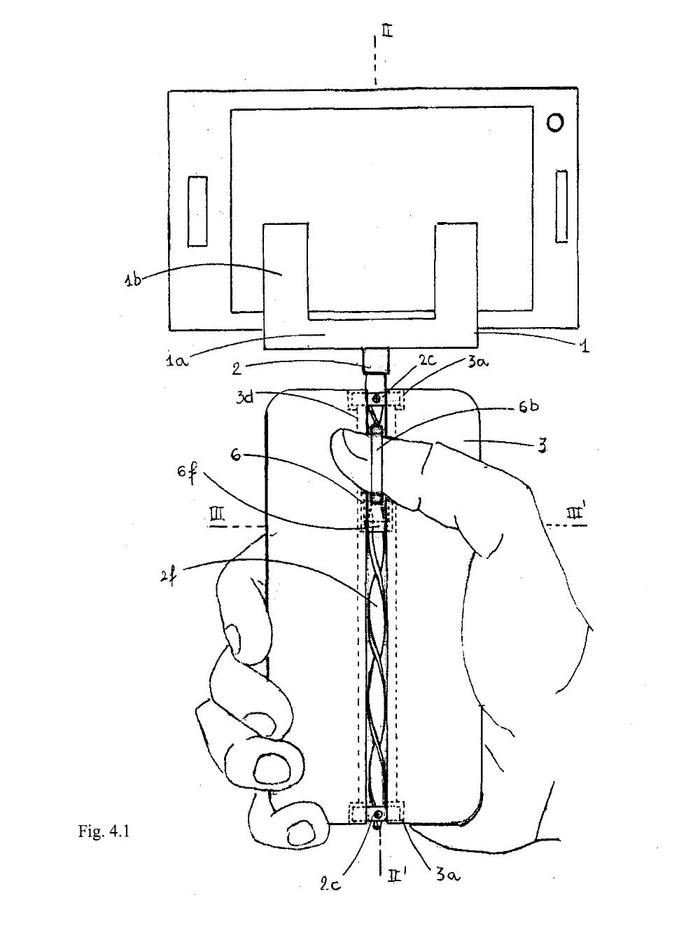

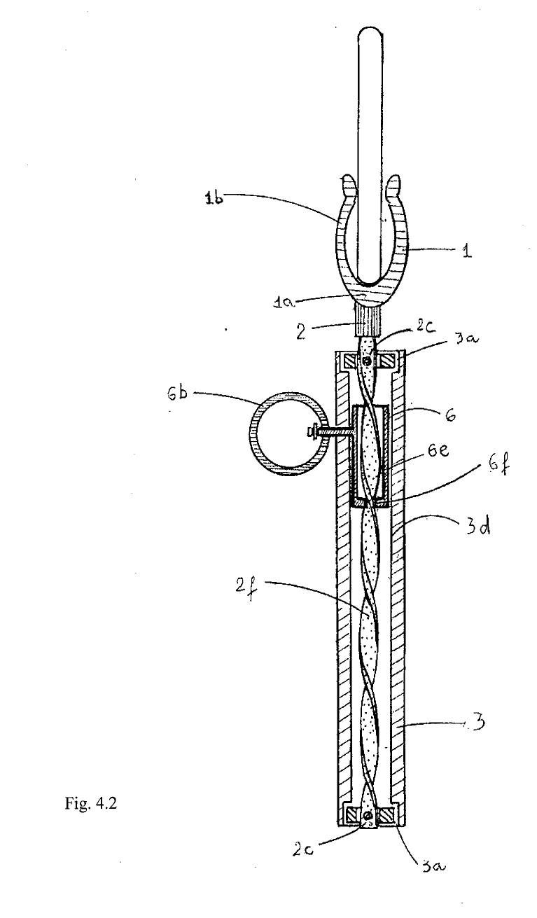

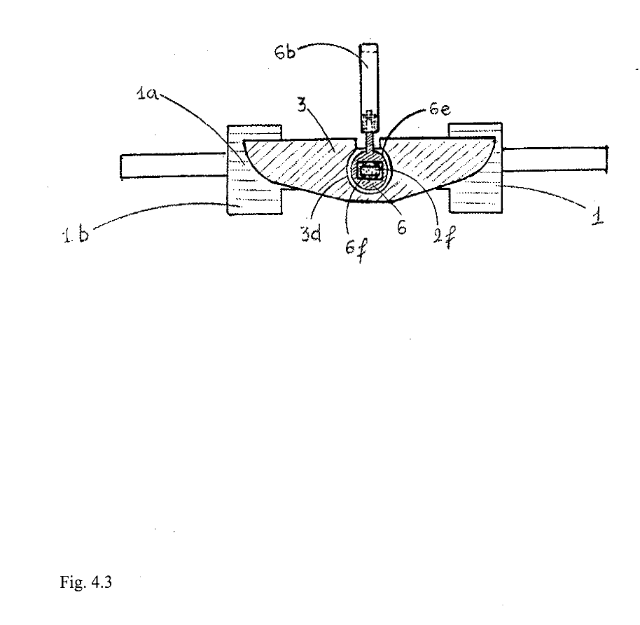

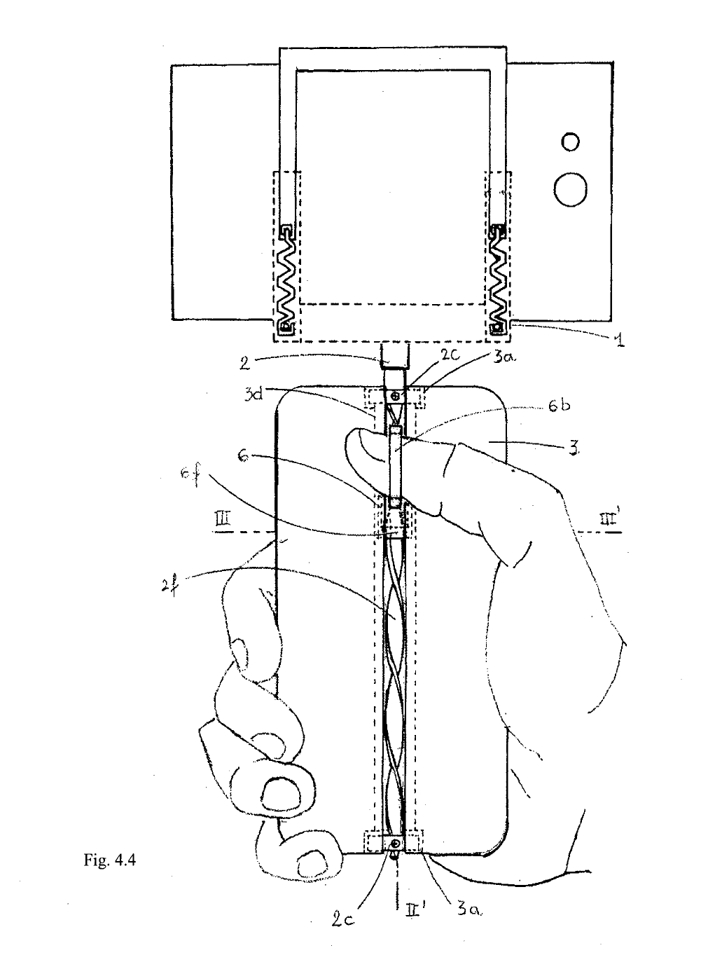

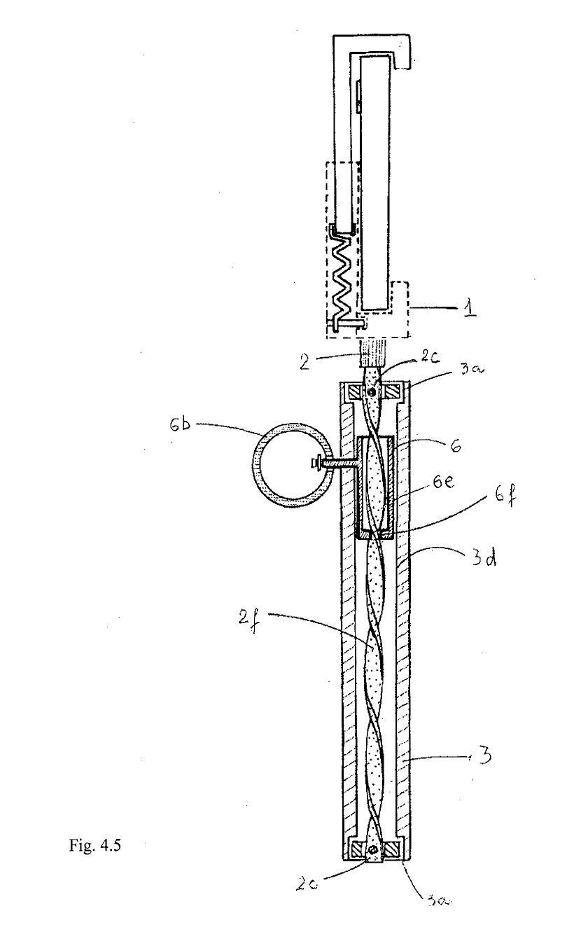

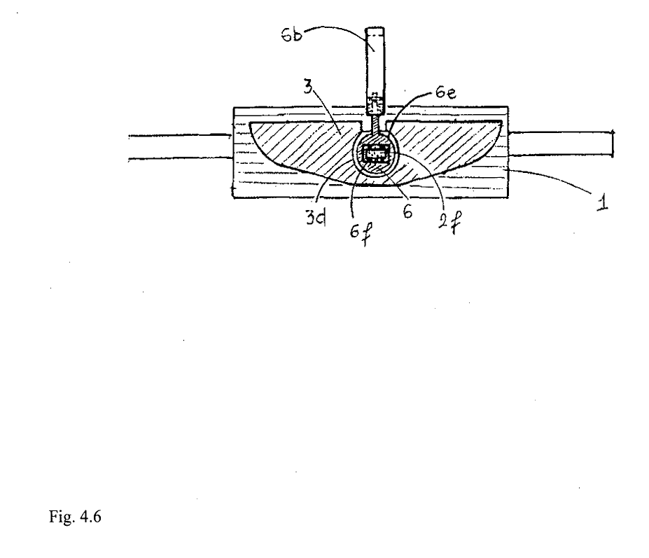

Annotation of symbol numbers for parts and members in FIG. 1.1, FIGS. 1.2, 1.3 and 1.4.:

Numbers of Part 1:
No. 1 is the overall part of the mobile phone retainer.
No. 1a is a horizontal bar that functions as a holding seat for the mobile phone retainer.
No. 1b is clamping bars for the mobile phone retainer.

Numbers of Part 2:
No. 2 is the overall part of the rotation axis connected to the retaining frame (1) to rotate the retaining frame (1).—No. 2a is an open section with a large diameter and with raised edges to provide roughness on the finger when the user rotates the pivot with the fingers directly.
No. 2b is a section with a small diameter and raised ridges to provide roughness on the finger when the user rotates the pivot with the fingers directly.
No. 2c is the center of the pivot of the part in the bearing.

Numbers of Part 3:
No. 3 is the overall part of the pivot (1) retainer.
No. 3a is the bearings of the pivot (1).
No. 3b, center-retaining tube used to connect the pivot retainer (3) and the handle (4).

Numbers of Part 4:
No. 4 is the overall part of the handle.

Numbers of Part 5:
No. 5, center used to connect the pivot retainer (3) and the handle (4).
No. 5a is a male-threaded head for screwing and holding the balance position between the handle (4) and the pivot retainer (3).
No. 5b is the nut to screw into the center head (5a) to hold the required position between the handle (4) and the pivot retainer (3).

FIG. 2.1: Control device by moving to apply forces making movement of to-an-fro rack bar in the straight line in comparison with mobile phone clamp-styled retainer to the two surfaces of the mobile phone.

FIG. 2.2: Cross-sectional description of the device along cross-section I-I′ of FIG. 2.1

FIG. 2.3: Control device by moving index finger in a straight line with the holding hand using the mobile phone clamp-styled retainer to the two edges of the mobile phone.

Annotation of symbol numbers for parts and members in FIG. 2.1, FIGS. 2.2, and 2.3:

Numbers of Part 1:
No. 1 is the overall part of the mobile phone retainer.
No. 1a is a horizontal bar that functions as a holding seat for the mobile phone retainer.
No. 1b is clamping bars for the mobile phone retainer.

Numbers of Part 2:
No. 2 is the overall part of the rotation axis connected to the retaining frame (1) to rotate the retaining frame (1).
No. 2d is a pivot part in the form of cylindrical gears.
No. 2c is the center of the pivot of the part in the bearing.

Numbers of Part 3:
No. 3 is the overall part of the pivot retainer.
No. 3a is the bearings of the pivot (1).
No. 3b, center-retaining tube used to connect the pivot retainer (3) and the handle (4).
No. 3e is the open tube for the round cylinder with the coaxial teeth (6a) to slide back and forth.

Numbers of Part 4:
No. 4 is the overall part of the handle.

Numbers of Part 5:
No. 5 is center used to connect the pivot retainer (3) and the handle (4).
No. 5a is a male-threaded head for screwing and holding the balance position between the handle (4) and the pivot retainer (3).
No. 5b is the nut to screw into the center head (5a) to hold the required position between the handle (4) and the pivot retainer (3).

Numbers of Part 6:
No. 6 is an overall part with a toothed cylinder that moves back and forth horizontally and vertically to receive force from the control of the index finger (or middle finger).
No. 6a is a round cylinder with coaxial teeth.
No. 6b is a closed ring for placing the index finger (or middle finger).

FIG. 3.1: Control device by moving fingers in a circular arc formed with mobile phone clamp-styled retainer to the two surfaces of the mobile phone.

FIG. 3.2: Description of the device seen from the left of FIG. 3.1.

FIG. 3.3: Control device by moving index finger in a circular arc with the holding hand using the mobile phone clamp-styled retainer to the two edges of the mobile phone.

FIG. 3.4: Description of the device seen from the left, according to FIG. 3.3.

Annotation of symbol numbers for parts and members in FIG. 3.1, FIGS. 3.2, 3.3 and 3.4.:

Numbers of Part 1:
No. 1 is the overall part of the mobile phone retainer.
No. 1a is a horizontal bar that functions as a holding seat for the mobile phone retainer.
No. 1b is clamping bars for the mobile phone retainer.

Numbers of Part 2:
No. 2 is the overall part of the rotation axis connected to the retaining frame (1) to rotate the retaining frame (1).
No. 2e is a pivot part in the form of blunted cone.
No. 2c is the center of the pivot of the part in the bearing.

Numbers of Part 3:
No. 3 is the overall part of the pivot retainer.
No. 3a is bearings of the pivot (1).
No. 3b, center-retaining tube used to connect the pivot retainer (3) and the handle (4).
No. 3c is the bearings of the pied fantail gear segment (6c).

Numbers of Part 4:
No. 4 is the overall part of the handle.

Numbers of Part 5:
No. 5 is center used to connect the pivot retainer (3) and the handle (4).
No. 5a is a male-threaded head for screwing and holding the balance position between the handle (4) and the pivot retainer (3).
No. 5b is a bolt nut to screw into the center head (5a) to hold the required position between the handle (4) and the pivot retainer (3).

Numbers of Part 6:
No. 6 is an overall part of rack bar that moves back and forth in a curve arc to receive force from the control of the index finger (or middle finger).
No. 6b is a closed ring for placing a thumb.
No. 6c is the pied fantail gear segment.
No. 6d is center of the pied fantail gear segment (6c).

FIG. 4.1: Control device by moving fingers up and down vertically in comparison with mobile phone clamp-styled retainer to the two surfaces of the mobile phone.

FIG. 4.2: Cross-sectional description of the device seen from the left of FIG. 4.1. along the cross-section II II′.

FIG. 4.3: Cross-sectional description of the device seen upwards of FIG. 4.1. along the cross-section III III′.

FIG. 4.4 Control device by moving fingers up and down vertically in comparison with mobile phone clamp-styled retainer to the two edges of the mobile phone.

FIG. 4.5: Cross-sectional description of the device seen from the left of FIG. 4.4. along the cross-section II II′.

FIG. 4.6: Cross-sectional description of the device seen upwards of FIG. 4.4. along the cross-section III III′.

Annotation of symbol numbers for parts and members in FIG. 4.1, FIGS. 4.2, 4.3. 4.4, 4.5 and 4.6:

Numbers of Part 1:
No. 1 is the overall part of the mobile phone retainer.
No. 1a is a horizontal bar that functions as a holding seat for the mobile phone retainer.
No. 1b is clamping bars for the mobile phone retainer.

Numbers of Part 2:
No. 2 is the overall part of the rotation axis connected to the retaining frame (1) to rotate the retaining frame (1).
No. 2c is the center of the pivot of the part in the bearing.
No. (20 is a pivot in the form of a screw axe (drilling bit-shaped).

Numbers of Part 3:
No. 3 is the overall part of the pivot retainer (1) and also functions as a handle.
No. 3a is the bearings of the pivot (1).
No. 3b, center-retaining tube used to connect the pivot retainer (3) and the handle (4).
No. 3d is an open groove or open duct that surrounds the pivot to direct a part of member No. 6 to move up and down inside.

Numbers of Part 4:
No. 4 is the part of the handle.

Numbers of Part 5:
No. 5 is a coupler to connect the handle unit (4) and the pivot retainer (3)

Numbers of Part 6:
No. 6 is a general section of the rack bar or screw axle or conical gears that moves back and forth to receive force by the control of the finger.
No. 6e is a sliding piece with a cross section similar to that of an open groove or open duct (3d) so that it can slide up and down in those open groove or open duct (3d).
No. 6f is a hole with a cross section similar to the pivot in screw form (20 so that when the part (6) moves up and down, the pivot (2) will rotate forward or backward.

### DETAILED DESCRIPTION OF THE INVENTION

1—Description of a Hand-Held Device of Rotating Mobile Phone (Smartphone with Screen) with 360° Recording by Directly Rotating Pivot with Fingers (See FIG. 1.1, FIG. 1.2, FIG. 1.3 and FIG. 1.4):

The device includes a mobile phone holder 1 with a mobile phone equipped with a screen and a back camera, holder 1 in the form of a pair of clips 1b, having function of clipping the two sides of the mobile phone and with horizontal seat 1a.

In the middle and under and in the middle of the seat 1a is pivot 2. Frame 3 is a pivot retainer with a bearing 3a which holds the pivot segment 2c and enables the center segment 2c to rotate freely within the bearing 3a. On frame 3, there is a cylindrical hollow tube 3b and a cylindrical center 5 inside the hollow tube 3b with a diameter approximately equal to that of the hollow tube 3b and center 5 connected to the handle 4. The top end of the cylindrical center 5 having male thread 5a and cylindrical center 5 located in the hollow tube 3b and its top end protruding from the pipe 3b. Additionally, top end with the male thread 5a for the nut 5b to be screwed in to form the joints between the handle 4 with the pivot bracket 3 to allow comfortable position for each user.

When using the device, the mobile phone is inserted inside the clamps of the bracket 1, the user holds the handle 4 in the palm, and then opens the operation mode for the snapshot camera of automatic mode, or turn on the camera, and then use the index finger (or middle finger) to rotate the axis of the exposed section with raised edge 2a, or rotate it directly with the thumb and the index finger (or the thumb with the middle finger or the thumb with the two index fingers and the middle finger next to each other) the exposed section has a raised edge 2b, the camera will rotate according to the user's intention to face the camera to the scene needing to be recorded and can record an arc of 360° s or more.

Pictures or movies recorded when viewed will show panoramic view around the user. In case the user does not want to be in the picture or the recording, the user can sit down and raise handle of the device and mobile phone over the head and manipulate each finger to rotate the axis directly to control the recording.

Images or movies recorded can be viewed immediately on mobile phone or processed by the 360° VR application software on mobile phones so that after the process, the user can view photos or movies recorded in the form of a 360° VR, in which virtual reality images or movies can be viewed in full panorama by tapping the screen or by rotating the mobile phone.

2—Describe the Type of 360° Recording Mobile Phone Rotary Handheld Devices Controlled by Moving the Index Finger in Vertical Motion (See FIG. 2.1, FIG. 2.2 and FIG. 2.3):

Similar to the finger-controlled 360° recording mobile phone rotary handheld device by rotating directly the pivot with the fingers as described of the device (1).

But in this case, the rotating axis of the 360° recording mobile phone rotary handheld device in this type has a segment of gear 2d, a straight cylinder with coaxial driving teeth 6a. And this hub 6a is perpendicular to the rotation axis 1 and engages to the teeth of gear segments 2d gear. The hub with teeth 6a is freely moving by sliding back and forth in the open duct 3e, with its cross-section of approximately those of cylinder with driving teeth 6a. Open pipe 3e located on the pivot retainer 3, the outer end of the straight cylinder with teeth 6 is a closed ring 6b for placing the index finger. The teeth of the cylindrical hub having driving teeth 6a to engage those of gear segment 2c

of the pivot 2, when the fingers move, causing the toothed cylindrical hub 6a move and consequently causing the pivot 2 to rotate and make the mobile phone turn to be able to record the scene up to attention of the user under an arc of probably 360 degrees or more.

Pictures or movies recorded when viewed will show panoramic view around the user. In case the user does not want to be in the picture or the recording, the user can sit down and raise handle of the device and mobile phone over the head and manipulate each finger to rotate the axis directly to control the recording.

Images or movies recorded can be viewed immediately on mobile phone or processed by the 360° VR application software on mobile phones so that after the process, the user can view photos or movies recorded in the form of a 360° VR, in which virtual reality images or movies can be viewed in full panorama by tapping the screen or by rotating the mobile phone.

3—Describe the type of 360° recording mobile phone rotary handheld devices controlled by moving the index finger in a curve arc (see FIG. 3.1 and FIG. 3.2):

Similar to the finger-controlled 360° recording mobile phone rotary handheld device by rotating directly the pivot with the fingers as described of the device (1).

But in this case, the lower end of the pivot is a blunted-cone pivot section 2e coaxial to the pivot 2. A fan-shaped plate with concentric teeth located on the circumference 6c, on which there is a center 6d perpendicular to the surface of the fan-shaped plate. The center 6d is fixed and can be freely rotated because the bearing 3c is located on the retaining frame 3 and helps the teeth of the fan-shaped plate 6c to engage the blunted cone gear 2e gears. The outer of a cylindrical straight hub 6 is a closed ring 6b for placing the index finger. When the finger moves, the fan-shaped plate 6 accordingly rotates and makes the blunted cone gear 2e rotate, and consequently make the mobile phone turn to be able to record the scene according to intention of the user under an arc of probably 360 degrees or more.

Pictures or movies recorded when viewed will show panoramic view around the user. In case the user does not want to be in the picture or the recording, the user can sit down and raise handle of the device and mobile phone over the head and manipulate each finger to rotate the axis directly to control the recording.

Images or movies recorded can be viewed immediately on mobile phone or processed by the 360° VR application software on mobile phones so that after the process, the user can view photos or movies recorded in the form of a 360° VR, in which virtual reality images or movies can be viewed in full panorama by tapping the screen or by rotating the mobile phone.

4—Describe the Type of 360° Recording Mobile Phone Rotary Handheld Device Controlled by Moving the Thumb Up and Down (See FIGS. 4.1, 4.2, and 4.3):

Similar to the finger-controlled 360° recording mobile phone rotary handheld device by rotating directly the pivot with the fingers as described of the device (1).

But in this case, the lower end of the pivot of the finger-controlled 360° recording mobile phone rotary handheld device is the screw axle (drilling bit-shaped) 2f, a block 6e with a peripheral cross-section similar to that of the open groove or open duct (3d) so that it can slide up and down in these open groove or duct (3d), 6f as a hole with its cross-section is the same as the those of the screw axle (2f), so that when the part (6) moves up and down, the pivot (2) will rotate in the to-and-fro direction. The outside of thumb-controlled device 6 is a closed ring 6b to place the thumb, and when the thumb moves up and down it will cause the unit 6e to move up and down and rotate the drill bit-shaped screw axle 2f back and forth. This consequently enables the mobile phone to record the scene according to the user's intention with a recording arc of 360° or more.

Pictures or movies recorded when viewed will show panoramic view around the user. In case the user does not want to be in the picture or the recording, the user can sit down and raise handle of the device and mobile phone over the head and manipulate each finger to rotate the axis directly to control the recording.

Images or movies recorded can be viewed immediately on mobile phone or processed by the 360° VR application software on mobile phones so that after the process, the user can view photos or movies recorded in the form of a 360° VR, in which virtual reality images or movies can be viewed in full panorama by tapping the screen or by rotating the mobile phone.

1-11. (canceled)

12. A rotary hand-held device for mobile phone (smartphone) equipped with camera and a video-recording screen, or portable camera controlled by rotating the pivot directly by one or several fingers, the device comprising:
a holding frame used to hold the mobile phone so that its screen is positioned parallel with or nearly parallel with the user's direction, the holding frame may be in clamping shape to clamp to the sides or the upper and lower edges of the mobile phone, or in symmetrical or asymmetrical shape to clamp to the front and back surfaces of the mobile phone, or the holding frame may be of planar or vertical shape with the vertical bar or vertical planes of the holding frame having a sticking or magnetic element or cupped cover so that the mobile phone can be tightly attached to the holding frame;
a circular cylindrical spindle (hereinafter referred to as the pivot) is connected to the mobile phone holding frame in the lower and middle position of the holding frame and on the pivot there is at least one short segment serving as the center of the pivot, and on the pivot there is at least one open segment where the finger can be contacted by brushing or by directly rotating the pivot right at the open segment, such segment should have raised ridges to increase friction with finger; and
a holding frame of the pivot, on this holding frame there should be at least one bearing to retain the shaft of the pivot so that it can rotate freely in this bearing, in addition, this holding frame of the pivot should have an opening or be shorter in length in comparison with the pivot so that the pivot have exposed segment where users' fingers can contact, transferring forces to create rotary motion for the pivot, the holding frame of the pivot may also serve as the handle of the device.

13. A rotary hand-held device for mobile phone (smartphone) equipped with camera and a video-recording screen, or portable camera controlled by moving the index finger in vertical motion, the device comprising:
a holding frame used to hold the mobile phone so that its screen is positioned parallel with or nearly parallel with the user's direction, the holding frame may be in clamping shape to clamp to the sides or the upper and lower edges of the mobile phone, or in symmetrical or asymmetrical shape to clamp to the front and back surfaces of the mobile phone, or the holding frame may be of planar or vertical shape with the vertical bar or vertical planes of the holding frame having a sticking or magnetic element or cupped cover so that the mobile phone can be tightly attached to the holding frame;
a circular cylindrical pivot is connected to the mobile phone holding frame at the bottom and in the middle of the frame, and on the pivot there should be at least one short segment serving as the center of the pivot, a circular cylindrical gear is attached to the pivot and coaxial to it;
a bar in polygonal or cylindrical shape with coaxial teeth located on the outer surface, which engages the teeth of the gears of the pivot, one end of the polygonal or cylindrical bar is connected to a closed or open ring where the index finger may be put in; and
a holding frame of the pivot, on which there should be at least one bearing to hold the center of the pivot, and a pipe with a cross-section similar to that of the polygonal-shaped bar or a similar cross-section with those of cylindrical rod with coaxial teeth located on the outside surface, the pipe allows the polygonal-shaped bar or cylindrical-shaped rod to slide back and forth in the hollow tube and the frame may also serve as the handle of the device.

14. A rotary hand-held device for mobile phone (smartphone) equipped with camera and a video-recording screen, or portable camera controlled by moving the finger in a curve arc, the device comprising:
a holding frame used to hold the mobile phone so that its screen is positioned parallel with or nearly parallel with the user's direction, the holding frame may be in clamping shape to clamp to the sides or the upper and lower edges of the mobile phone, or in symmetrical or asymmetrical shape to clamp to the front and back surfaces of the mobile phone, or the holding frame may be of planar or vertical shape with the vertical bar or vertical planes of the holding frame having a sticking or magnetic element or cupped cover so that the mobile phone can be tightly attached to the holding frame;
a circular cylindrical pivot is connected to the mobile phone holding frame at the bottom and in the middle of the frame, and on the pivot there should be at least one short segment serving as the center of the pivot, a cone or blunted cone gear is attached to the pivot and coaxial to it;
a fan-shaped plate with teeth located on the perimeter, at the center of the sector there is a level perpendicular to the plane of the fan-shaped plate; other end of the sector is connected to a lever, and this end of the lever is a closed or open ring to put the index finger in; and
a holding frame of pivot, on which there should at least one bearing to retain the level of the pivot and one to hold the level of the fan-shaped plate so that such plate can engage with cone or blunted cone gear and enables this plate to rotate, the holding frame of pivot may also serve as the handle of the device.

15. A rotary hand-held device for mobile phone (smartphone) equipped with camera and a video-recording screen, or portable camera controlled by moving the thumb up and down in a straight line, the device comprising:
a holding frame used to hold the mobile phone so that its screen is positioned parallel with or nearly parallel with the user's direction, the holding frame may be in clamping shape to clamp to the sides or the upper and lower edges of the mobile phone, or in symmetrical or asymmetrical shape to clamp to the front and back surfaces of the mobile phone, or the holding frame may be of planar or vertical shape with the vertical bar or vertical planes of the holding frame having a sticking or magnetic element or cupped cover so that the mobile phone can be tightly attached to the holding frame;
a circular cylindrical pivot is connected to the mobile phone holding frame at the bottom and in the middle of the frame, and on the pivot there should be at least one short segment serving as the center of the pivot, a drilling bit-shaped screw axle gear is attached to the pivot and coaxial to it;
a sliding block with a hole of which cross-section is similar to that of the drill bit-shaped screw axle and is connected to a closed or open ring to put the thumb in, and this block can run up and down along the length of the drill bit-shaped screw axle; and
a holding frame of the pivot on which there should be at least one bearing to hold the level of the pivot, and such frame can serve as the handle of the device.
